(19) United States
(12) Patent Application Publication
(10) Pub. No.: US 2017/0134282 A1
(43) Pub. Date: May 11, 2017

(54) PER QUEUE PER SERVICE DIFFERENTIATION FOR DROPPING PACKETS IN WEIGHTED RANDOM EARLY DETECTION

(71) Applicant: Ciena Corporation, Hanover, MD (US)

(72) Inventors: Shivam AGARWAL, Allahabad (IN); Himanshu PREMI, Delhi (IN)

(21) Appl. No.: 14/978,225

(22) Filed: Dec. 22, 2015

(30) Foreign Application Priority Data
Nov. 10, 2015 (IN) 3678/DEL/2015

(51) Int. Cl. H04L 12/801; H04L 12/823; H04L 12/807

(52) U.S. Cl. CPC H04L 47/12; H04L 47/27; H04L 47/32

(57) ABSTRACT

Systems and methods for per service differentiation for congestion avoidance through dropping packets based on service priority include receiving an ingress packet; responsive to no congestion, providing the ingress packet to a queue of one or more queues; and, responsive to congestion, during a congestion window, one of providing the ingress packet to the queue and dropping the packet based on a packet dropping capability and service priority of a service associated with the packet.

### CROSS-REFERENCE TO RELATED APPLICATION(S)

The present patent application/patent claims the benefit of priority of Indian Patent Application No. 3678/DEL/2015, filed on Nov. 10, 2015, and entitled “PER QUEUE PER SERVICE DIFFERENTIATION FOR DROPPING PACKETS IN WEIGHTED RANDOM EARLY DETECTION,” the contents of which are incorporated in full by reference herein.

### FIELD OF THE DISCLOSURE

The present disclosure generally relates to networking systems and methods. More particularly, the present disclosure relates to per queue, per service differentiation for dropping packets in Weighted RED (WRED), etc.

### BACKGROUND OF THE DISCLOSURE

In data networks, Random Early Detection (RED) is an active queue management technique for congestion avoidance. In contrast to traditional queue management techniques, which packets are dropped only when a buffer is full, the RED algorithm drops arriving packets probabilistically. The probability of drop increases as the estimated average queue size grows. Note that RED responds to a time-averaged queue length, not an instantaneous one. Thus, if the queue has been mostly empty in the “recent past,” RED will not tend to drop packets (unless the queue overflows). On the other hand, if the queue has recently been relatively full, indicating persistent congestion, newly arriving packets are more likely to be dropped. The RED technique includes two parts, namely estimation of the average queue size and the decision of whether or not to drop an incoming packet.

Weighted random early detection (WRED) is a queueing technique for a network scheduler suited for congestion avoidance. It is an extension to RED where a single queue may have several different queue thresholds. In WRED, there can be different probabilities for different priorities (e.g., Internet Protocol (IP) precedence, Differentiated Services Code Point (DSCP), etc.). Whenever congestion occurs at an egress queue, then packets will be dropped randomly by WRED (or RED) to prevent/overcome congestion on that queue irrespective of the service associated with the traffic.

Currently, a user has no capability to give precedence to one service over another service during a congestion scenario at the same egress queue; rather a user has to provision different WRED profiles across queues without the flexibility to provide precedence to service on the same egress queue. Due to this limitation, the user is unable to prioritize the traffic coming from different services to a single queue within the congestion window; accordingly, traffic from different services will be dropped randomly during the congestion scenario within the congestion window. For example, consider a queue size of 100 bytes with a WRED green threshold of 60/80 (lower/upper) in percentages and drop rate be 10%, during congestion, traffic will drop when the queue size reaches at 60 bytes (60% of 100 bytes of the queue size) at a 10% drop rate until the queue size reaches to 80 bytes (80% of 100 bytes of the queue size) and after this all the traffic will be dropped. In the aforementioned scenario, traffic from different services coming to a single queue will be dropped randomly within the congestion window on which user does not have any control.

### BRIEF SUMMARY OF THE DISCLOSURE

In an exemplary embodiment, a method for per service differentiation for congestion avoidance through dropping packets based on service priority includes receiving an ingress packet; responsive to no congestion, providing the ingress packet to a queue of one or more queues; and, responsive to congestion, during a congestion window, one of providing the ingress packet to the queue and dropping the packet based on a packet dropping capability and service priority of a service associated with the packet. The congestion can be determined if the queue is filled greater than a minimum queue threshold, and wherein the congestion window can be when the queue is filled greater than the minimum queue length threshold and less than or equal to maximum queue length threshold. The method can include, responsive to the congestion and outside the congestion window, dropping the packet. The service priority can be implemented in a Weighted Random Early Detection technique. The queue can support traffic including a plurality of services, and wherein each of the plurality of services has an associated priority used by the service priority to determine whether or not to drop the packet. In the congestion window, the dropping is not random, but can be based on the service priority, and, responsive to the congestion and outside of the congestion window, the dropping is for all services. The queue can support traffic including a plurality of services defined through any of Virtual Local Area Network (VLAN) identifiers, service identifiers in IEEE 802.1ah, a Type of Service (ToS) in IP headers, and tunnel identifiers. The service priority can be one of user-defined, determined from Differentiated Services (Diff-Serv), and based on IEEE 802.1Q priority. The service priority can be utilized to differentiate data traffic and control traffic on the queue to provide a higher priority for the control traffic. The service priority can be utilized to differentiate voice traffic and video traffic on the queue to provide a higher priority for the voice traffic.

In another exemplary embodiment, an apparatus adapted for per service differentiation for congestion avoidance through dropping packets based on service priority includes circuitry adapted to receive an ingress packet; and congestion avoidance circuitry adapted to, responsive to no congestion, provide the ingress packet to a queue of one or more queues, and, responsive to congestion, during a congestion window, one of provide the ingress packet to the queue and drop the packet based on a packet dropping capability and service priority of a service associated with the packet. The congestion can be determined if the queue is filled greater than a minimum queue threshold, and wherein the congestion window is when the queue is filled greater than the minimum queue length threshold and less than or equal to maximum queue length threshold, and wherein the congestion avoidance circuitry is further adapted to, responsive to the congestion and outside the congestion window, drop the packet. The service priority can be implemented in a Weighted Random Early Detection technique. The queue can support traffic including a plurality of services, and wherein each of the plurality of services has an associated priority used by the service priority to determine whether or not to drop the packet. In the congestion window, the packet is not dropped randomly, but can be based on the service priority, and, responsive to the congestion and outside of the congestion window, the packet is always dropped, regardless of the service priority. The queue can support traffic including a plurality of services defined through any of Virtual Local Area Network (VLAN) identifiers, service identifiers in IEEE 802.1ah, a Type of Service (ToS) in IP headers, and tunnel identifiers. The service priority can be one of user-defined, determined from Differentiated Services (Diff-Serv), and based on IEEE 802.1Q priority. The service priority can be utilized to differentiate data traffic and control traffic on the queue to provide a higher priority for the control traffic. The service priority can be utilized to differentiate voice traffic and video traffic on the queue to provide a higher priority for the voice traffic.

In a further exemplary embodiment, a node adapted for per service differentiation for congestion avoidance through dropping packets based on service priority includes one or more line ports including circuitry adapted to receive an ingress packet; and congestion avoidance circuitry adapted to, responsive to no congestion, provide the ingress packet to a queue of one or more queues, and, responsive to congestion, during a congestion window, one of provide the ingress packet to the queue and drop the packet based on a packet dropping capability and service priority of a service associated with the packet.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a flowchart of a WRED process;

FIG. 2 is a graph of an operation of the WRED process of FIG. 1;

FIG. 3 is a flowchart of a WRED process incorporating service priority logic therein;

FIG. 4 is a block diagram of an exemplary implementation of the service priority logic from the WRED process of FIG. 3;

FIG. 5 is a block diagram of packet congestion avoidance circuitry adapted to implement the WRED processes of FIG. 3 and the service priority logic;

FIG. 6 is a block diagram of an exemplary implementation of a node for implementation of the WRED process of FIG. 3 and the service priority logic; and

FIG. 7 is a block diagram of another exemplary implementation of a node for implementation of the WRED process of FIG. 3 and the service priority logic.

### DETAILED DESCRIPTION OF THE DISCLOSURE

In various exemplary embodiments, the present disclosure relates to systems and methods for per queue, per service differentiation for dropping packets in WRED, etc. The systems and methods allow a user the capability to provision a priority-based dropping capability for per queue per service within a WRED window. Accordingly, the user has the flexibility to provide precedence to one service over another service landing on the same egress queue. Again, prior to the systems and methods, for a particular queue, a user is unable to prioritize traffic within the WRED congestion window based on the services on the traffic. The systems and methods provide the capability to the user to prioritize one service over the other within a particular queue according to associated needs based on service priority. Advantageously, the systems and methods enable users to give more importance to a particular service within the congestion window.

The systems and methods contemplate various use cases. First, for example, if both data traffic and control traffic lands on the same queue, the user has the option to provide higher priority to control traffic. Second, for example, the systems and methods could be used to preference voice over video traffic. For example, consider a scenario where a single user sends two streams, one corresponding to voice while other to video, the systems and methods could provide more precedence to voice over video in case of congestion thereby user getting relieved to map voice and video traffic to different streams. Third, for example, for a service, the user can have the flexibility to make a queue behave like strict priority even when the queue is configured as a non-strict priority, by provisioning the highest priority, within the queue, to a service in question. Thus, traffic for this service will get dropped only when the port gets congested due to traffic from higher priority queue than the queue to which this service lands with.

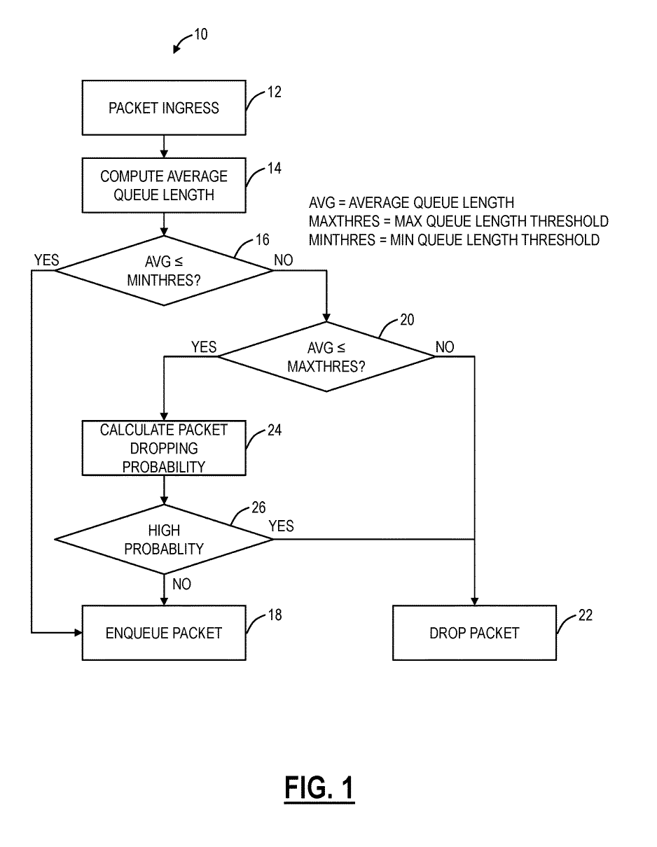

Referring to FIG. 1, in an exemplary embodiment, a flowchart illustrates a WRED process 10. Again, the WRED process is a queuing technique used by network schedulers to avoid congestion. RED is an improvement over tail drop techniques which buffer as many packets as possible and begins dropping when queues are filled. Tail drop distributes buffer space unfairly and can lead to network problems. The WRED process 10 monitors average queue size and drops packets based on statistical probabilities. If the buffer is almost empty, all incoming packets are accepted. As the queue grows, the probability for dropping an incoming packet grows too. When the buffer is full, the probability has reached 1, and all incoming packets are dropped. The WRED process 10 is fairer than tail drop, in the sense that it does not possess a bias against bursty traffic that uses only a small portion of the bandwidth. The more a host transmits, the more likely it is that its packets are dropped as the probability of a host's packet being dropped is proportional to the amount of data it has in a queue. Early detection helps avoid Transmission Control Protocol (TCP) global synchronization. WRED allows different probabilities for different priorities and/or queues.

In the WRED process 10, an incoming packet is received (ingress packet) (step 12) and the average queue length is computed (step 14). The average queue length is labeled AVG, and the WRED process 10 includes a maximum queue length threshold, MAXTHRES, and a minimum queue length threshold, MINTHRES. Note, conventional RED would have a single threshold whereas the WRED process 10 includes the multiple thresholds, MAXTHRES, MINTHRES, etc. If AVG is less than or equal to MINTHRES (step 16), the WRED process 10 includes enqueuing the incoming packet (step 18). If AVG is greater than to MINTHRES (step 16), the WRED process 10 checks if AVG is greater than or equal to MAXTHRES (step 20). If AVG is greater than MAXTHRES (step 20), the WRED process 10 includes dropping the packet (step 22). If AVG is less than or equal to MAXTHRES (step 20), the WRED process 10 includes calculating a packet dropping probability (step 24). If the packet dropping probability is high (step 26), the WRED process 10 includes dropping the packet (step 22). If the packet dropping probability is low (step 26), the WRED process 10 includes enqueuing the incoming packet (step 18).

Again, present solutions provide support of per egress queue WRED to prevent/overcome congestion. WRED is defined in Section 3 of IETF RFC 2309 “Recommendations on Queue Management and Congestion Avoidance in the Internet” (April 1998), the contents of which are incorporated by reference. Again, whenever congestion occurs at an egress queue, then ingress packets will be dropped randomly by the WRED process 10 to prevent/overcome congestion on that queue irrespective of the service from where the traffic is coming. The systems and methods provide the capability to give the precedence to one service over another service during a congestion scenario at the same egress queue.

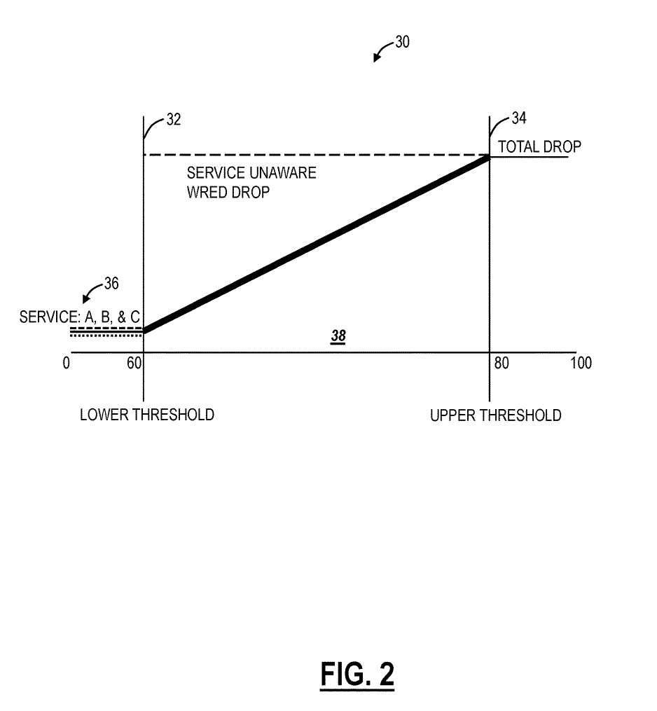

Referring to FIG. 2, in an exemplary embodiment, a graph illustrates an operation 30 of the WRED process 10. Assume, for illustration purposes, the operation 30 has a queue with a size of 100 bytes. In the exemplary operation 30, the MINTHRES is a lower threshold 32 of 60 bytes, and the MAXTHRES is an upper threshold 34 of 80 bytes. That is, the operation 30 has a WRED Green Threshold of 60/80 (lower/upper) in percentages, and a drop rate is 10%. This means that during congestion, traffic will start dropping when the queue size reaches 60 bytes (60% of 100 bytes of queue size) @ 10% (drop rate) until the queue size reaches to 80 Bytes (80% of 100 Bytes of queue size) and after this all the traffic will be dropped.

Also in the operation 30, there are three services 36, labeled as services A, B, C. As shown in FIG. 2, once the buffer hits the lower threshold 32, random drops begin to occur on the traffic during a WRED window 38, between the thresholds 32, 34 (both inclusive). In conventional operation, there is no way to prioritize the traffic coming from the different services 36 on the egress queue and, during congestion, traffic will be dropped randomly at the egress queue irrespective of the services 36.

The systems and methods provide the capability to provision priority-based dropping capability for per queue per service within the WRED window 38. Thus, the user has the flexibility to provide precedence to one service 36 over another service landing on the same egress queue. For example, in the operation 30, consider that traffic is coming on the egress queue from the three services 36 and each service is given some priority, such as from 0 to 7, to find out which packet should be dropped first during congestion.

Take the example of 100 packets out of which 2 packets of each service 36 (A, B & C) are falling above the lower threshold 32 during a congestion scenario. Hence, they become dropping candidates that may be dropped to prevent congestion. The systems and methods aim to prioritize the dropping candidates of different services 36. As described above, each service 36 is assigned a priority (or has a priority) and the dropping candidate packets will be dropped according to the priority assigned to the services 36. Again, for example, assume the services 36 have the following priorities:

| | |
|---|---|
| Service A | Priority 0 (lowest) |
| Service B | Priority 3 |
| Service C | Priority 7 (highest) |

Therefore, during a congestion scenario, first of all, service A's traffic will be dropped then service B's and then service C's traffic to prevent/overcome congestion.

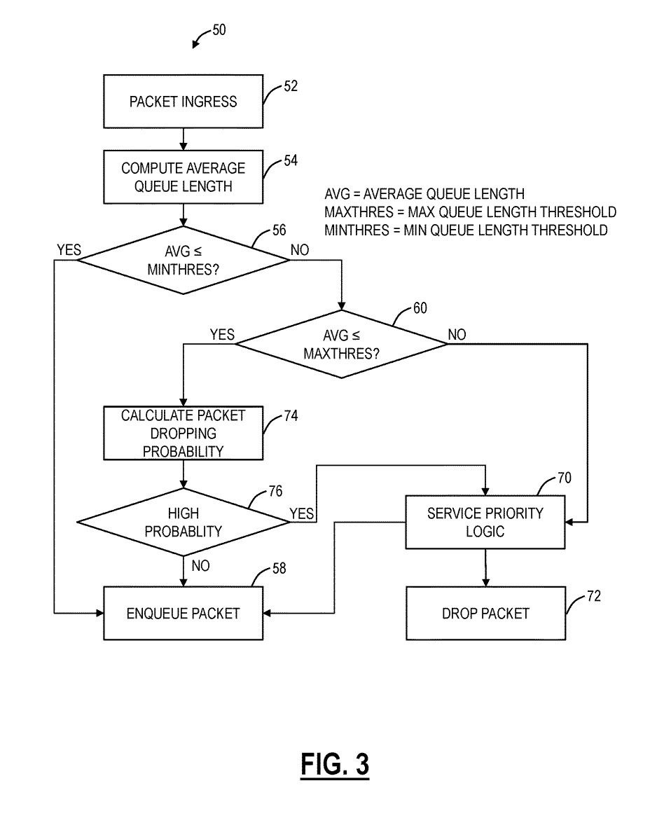

Referring to FIG. 3, in an exemplary embodiment, a flowchart illustrates a WRED process 50 incorporating service priority logic therein. The WRED process 50 contemplates operation on any switch, router, node, network element, etc. that supports WRED. That is, the WRED process 50 can be utilized with any buffer, queue, circuit, logic, etc. that queues packets and implements congestion avoidance. The WRED process 50 enable a user to provision priority-based dropping for per queue per service within the WRED window 38. Accordingly, the user has the flexibility to provide precedence to one service over another service landing on the same egress queue.

In the WRED process 50, an incoming packet is received (ingress packet) (step 52) and the average queue length is computed (step 54). The average queue length is labeled AVG, and the WRED process 50 includes a maximum queue length threshold, MAXTHRES, and a minimum queue length threshold, MINTHRES. Note, conventional RED would have a single threshold whereas the WRED process 50 includes the multiple thresholds, MAXTHRES, MINTHRES, etc. If AVG is less than or equal to MINTHRES (step 56), the WRED process 50 includes enqueuing the incoming packet (step 58). If AVG is greater than MINTHRES (step 56), the WRED process 50 checks if AVG is greater than or equal to MAXTHRES (step 60). If AVG is greater than MAXTHRES (step 60), the WRED process 50 includes executing the service priority logic (step 70) for dropping the packet (step 72). If AVG is less than or equal to MAXTHRES (step 60), the WRED process 50 includes calculating a packet dropping probability (step 74). If the packet dropping probability is high (step 76), the WRED process 50 includes executing the service priority logic (step 70) for dropping the packet (step 72). If the packet dropping probability is low (step 76), the WRED process 50 includes enqueuing the incoming packet (step 58).

The service priority logic 70 can be implemented within the current WRED technique to prioritize the traffic of different services 36 within a particular queue according to specific needs. The service priority logic 70 is implemented only within the WRED window 38. For the service priority logic 70, during a congestion scenario, i.e., when a queue is above the MINTHRES thereby in the WRED window 38, where some packets need to be dropped to prevent/overcome congestion, the service priority logic 70 decide whether a packet will be dropped or queued based on the priority assigned to each service. Priority can be assigned to each service by a user, determined from existing characteristics of the services, etc.

The services 36 can be distinguished in the traffic via 1) Virtual Local Area Network (VLAN) identifiers, 2) service identifiers such as from IEEE 802.1ah, 3) Type of Service (ToS) in IP headers, 4) tunnel identifiers, and the like. The priority can be 1) user-defined where user can prioritize traffic on the basis of the source/ingress port, 2) determined from Differentiated Services (Diff-Serv), 3) based on IEEE 802.1Q priority (0 to 7), and the like.

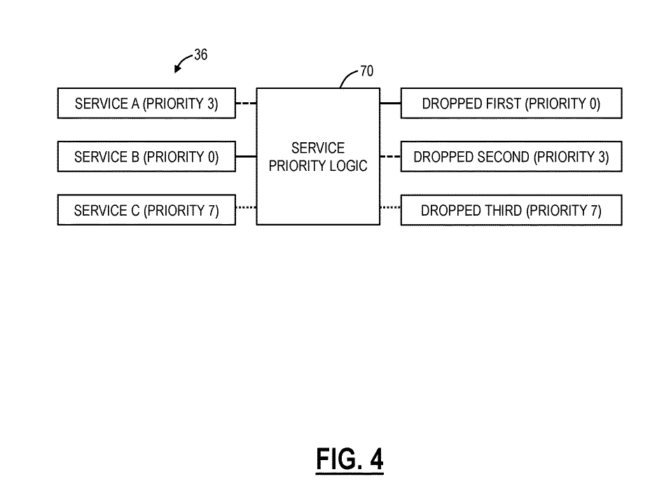

In the service priority logic 70, lower priority traffic will be dropped first, and then the next higher priority traffic, etc. until the congestion is removed. Referring to FIG. 4, in an exemplary embodiment, a block diagram illustrates an exemplary implementation of the service priority logic 70. Again, for example, the service priority logic 70 is illustrated with reference to the services 36 described in FIG. 2 each of which has a priority. Now suppose during congestion, the WRED process 50 has to drop these 3 services. In this scenario, the service priority logic 70 will check the priority of the services 36 (either assigned by the user or determined from the packet's header), and then based on the lowest priority, the service priority logic 70 will first drop the packet of service assigned the lowest priority after the next higher priority service will be dropped and so on.

Thus, in this example, the service priority logic 70 has the services 36 A, B, C with priorities 3, 0, 7, respectively. The service priority logic 70 determines the service 36 B is dropped first, the service 36 A is dropped second, and finally, the service 36 C is dropped last.

Again, the WRED processes 10, 50 and the service priority logic 70 can be implemented in any packet device. It is also possible the service priority logic 70 could be incorporated in Metro Ethernet Forum (MEF) services.

In an exemplary embodiment, a process for per service differentiation for congestion avoidance through dropping packets based on service priority includes receiving an ingress packet; responsive to no congestion, providing the ingress packet to a queue of one or more queues; and, responsive to congestion, during a congestion window, one of providing the ingress packet to the queue and dropping the packet based on a packet dropping capability and service priority of a service associated with the packet. The congestion can be determined if the queue is filled greater than a minimum queue threshold, and wherein the congestion window is when the queue is filled greater than the minimum queue length threshold and less than or equal to maximum queue length threshold. The method can further include responsive to the congestion and outside the congestion window, dropping the packet. The service priority can be implemented in a Weighted Random Early Detection technique. The queue can support traffic including a plurality of services, and wherein each of the plurality of services has an associated priority used by the service priority to determine whether or not to drop the packet.

In the congestion window, the dropping is not random, but based on the service priority, and, responsive to the congestion and outside of the congestion window, the dropping is for all services. The queue can support traffic including a plurality of services defined through any of Virtual Local Area Network (VLAN) identifiers, service identifiers in IEEE 802.1ah, a Type of Service (ToS) in IP headers, and tunnel identifiers. The service priority can be one of user-defined, determined from Differentiated Services (Diff-Serv), and based on IEEE 802.1Q priority. The service priority can be utilized to differentiate data traffic and control traffic on the queue to provide a higher priority for the control traffic. The service priority can be utilized to differentiate voice traffic and video traffic on the queue to provide a higher priority to the voice traffic.

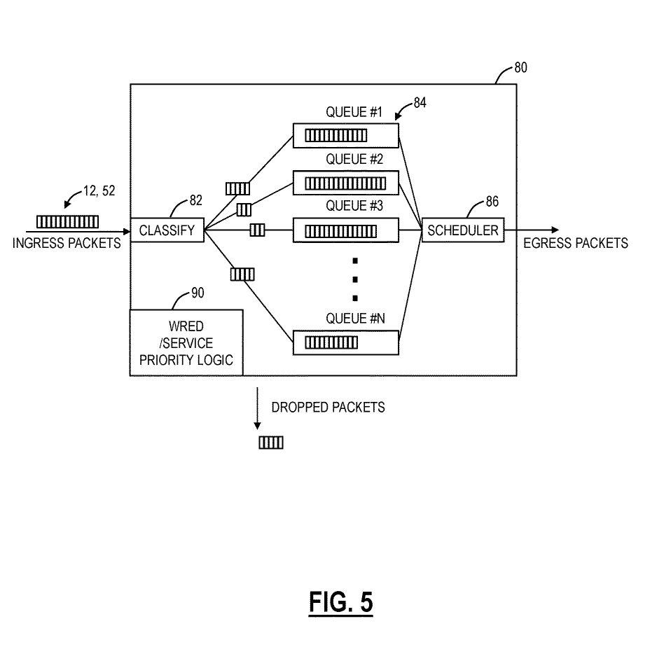

Referring to FIG. 5, in an exemplary embodiment, a block diagram illustrates packet congestion avoidance circuitry 80 adapted to implement the WRED processes 10, 50 and the service priority logic 70. The congestion avoidance circuitry 80 includes classification circuitry 82, one or more queues 84, scheduling circuitry 86, and WRED circuitry 90. The ingress packets, from steps 12, 52, are received by the classification circuitry 82. The classification circuitry 82 is adapted to identify the particular service associated with each ingressing packet and to provide the ingressing packet to one of the queues 84. The classification circuitry 82 is adapted to work with the WRED circuitry 90 to perform the WRED process 50 and the service priority logic 70. Specifically, the WRED circuitry 90 is adapted to intervene with the classification circuitry 82 and cause dropping of the ingressing packets based on congestion and through the WRED process 50 and the service priority logic 70. Thus, the packet congestion avoidance circuitry 80 enables congestion avoidance, via WRED, with per queue per service differentiation. The scheduler 86 is adapted to provide an egress packet stream from the one or more queues 84.

In an exemplary embodiment, an apparatus adapted for per service differentiation for congestion avoidance through dropping packets based on service priority includes circuitry adapted to receive an ingress packet; and congestion avoidance circuitry adapted to, responsive to no congestion, provide the ingress packet to a queue of one or more queues, and, responsive to congestion, during a congestion window, one of provide the ingress packet to the queue and drop the packet based on a packet dropping capability and service priority of a service associated with the packet. The congestion can be determined if the queue is filled greater than a minimum queue threshold, and wherein the congestion window is when the queue is filled greater than the minimum queue length threshold and less than or equal to maximum queue length threshold, and wherein the congestion avoidance circuitry can be further adapted to, responsive to the congestion and outside the congestion window, drop the packet.

The service priority can be implemented in a Weighted Random Early Detection technique. The queue can support traffic including a plurality of services, and wherein each of the plurality of services has an associated priority used by the service priority to determine whether or not to drop the packet. In the congestion window, the packet is not dropped randomly, but based on the service priority, and, responsive to the congestion and outside of the congestion window, the packet is always dropped, regardless of the service priority. The queue can support traffic including a plurality of services defined through any of Virtual Local Area Network (VLAN) identifiers, service identifiers in IEEE 802.1ah, a Type of Service (ToS) in IP headers, and tunnel identifiers. The service priority can be one of user-defined, determined from Differentiated Services (Diff-Serv), and based on IEEE 802.1Q priority. The service priority can be utilized to differentiate data traffic and control traffic on the queue to provide a higher priority for the control traffic. The service priority can be utilized to differentiate voice traffic and video traffic on the queue to provide a higher priority to the voice traffic.

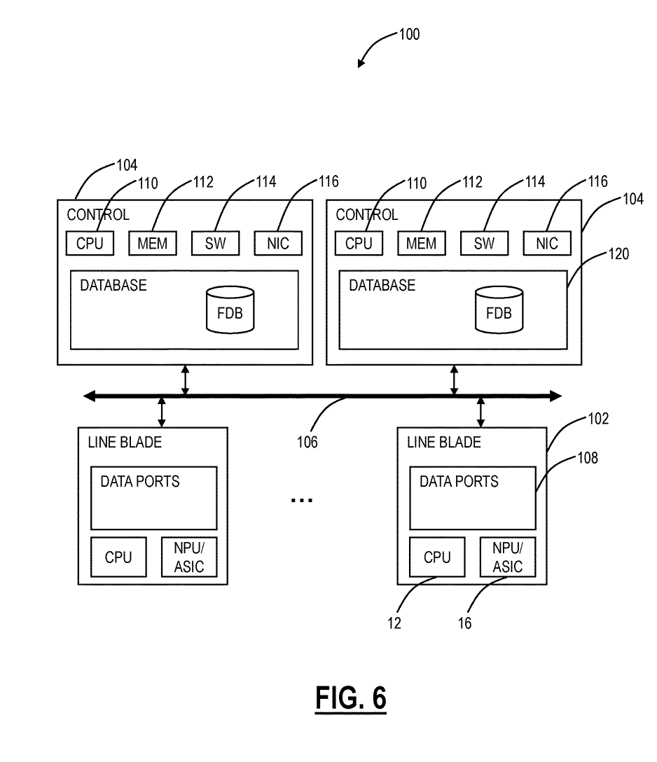

Referring to FIG. 6, in an exemplary embodiment, a block diagram illustrates an exemplary implementation of the node 100. In this exemplary embodiment, the node 100 is an Ethernet network switch, but those of ordinary skill in the art will recognize the systems and methods described herein contemplate other types of network elements and other implementations. In this exemplary embodiment, the node 100 includes a plurality of blades 102, 104 interconnected via an interface 106. The blades 102, 104 are also known as line cards, line modules, circuit packs, pluggable modules, etc. and generally refer to components mounted on a chassis, shelf, etc. of a data switching device, i.e., the node 100. Each of the blades 102, 104 can include numerous electronic devices and optical devices mounted on a circuit board along with various interconnects including interfaces to the chassis, shelf, etc.

Two exemplary blades are illustrated with line blades 102 and control blades 104. The line blades 102 generally include data ports 108 such as a plurality of Ethernet ports. For example, the line blade 102 can include a plurality of physical ports disposed on an exterior of the blade 102 for receiving ingress/egress connections. Additionally, the line blades 102 can include switching components to form a switching fabric via the backplane 106 between all of the data ports 108 allowing data traffic to be switched between the data ports 108 on the various line blades 102. The switching fabric is a combination of hardware, software, firmware, etc. that moves data coming into the node 100 out by the correct port 108 to the next node 100. “Switching fabric” includes switching units, or individual boxes, in a node; integrated circuits contained in the switching units; and programming that allows switching paths to be controlled. Note, the switching fabric can be distributed on the blades 102, 104, in a separate blade (not shown), or a combination thereof. The line blades 102 can include an Ethernet manager (i.e., a CPU) and a Network Processor (NP)/Application Specific Integrated Circuit (ASIC). As described herein, the line blades 102 can include the packet congestion avoidance circuitry 80 and/or be adapted to perform the WRED process 50 and the service priority logic 70.

The control blades 104 include a microprocessor 110, memory 112, software 114, and a network interface 116. Specifically, the microprocessor 110, the memory 112, and the software 114 can collectively control, configure, provision, monitor, etc. the node 100. The network interface 116 may be utilized to communicate with an element manager, a network management system, etc. Additionally, the control blades 104 can include a database 120 that tracks and maintains provisioning, configuration, operational data and the like. The database 120 can include a Forwarding Database (FDB). In this exemplary embodiment, the node 100 includes two control blades 104 which may operate in a redundant or protected configuration such as 1:1, 1+1, etc. In general, the control blades 104 maintain dynamic system information including Layer two forwarding databases, protocol state machines, and the operational status of the ports 108 within the node 100.

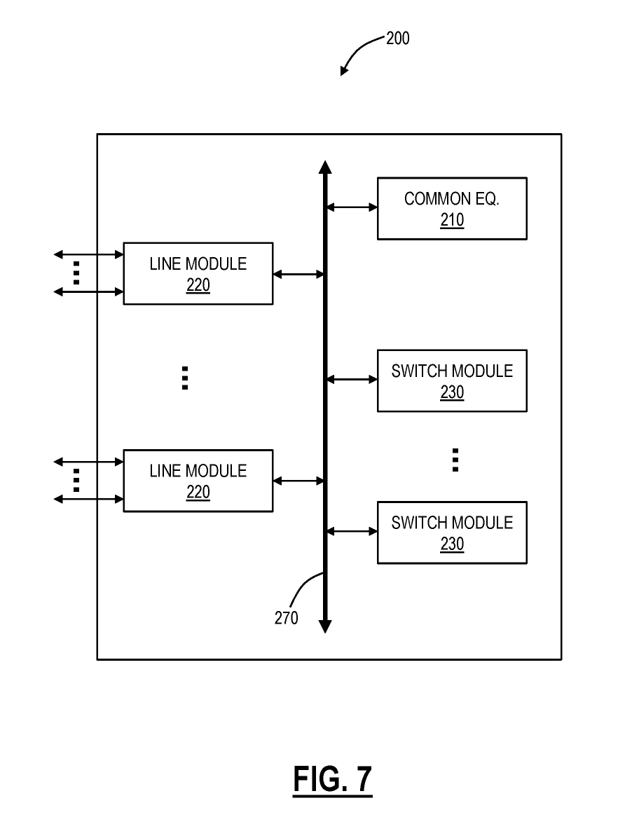

Referring to FIG. 7, in an exemplary embodiment, a block diagram illustrates another exemplary implementation of a node 200. For example, the node 100 can be a dedicated Ethernet switch whereas the node 200 can be a multiservice platform. In an exemplary embodiment, the node 200 can be a nodal device that may consolidate the functionality of a multi-service provisioning platform (MSPP), digital cross-connect (DCS), Ethernet and Optical Transport Network (OTN) switch, dense wave division multiplexed (DWDM) platform, etc. into a single, high-capacity intelligent switching system providing Layer 0, 1, and 2 consolidation. In another exemplary embodiment, the node 200 can be any of an OTN add/drop multiplexer (ADM), a multi-service provisioning platform (MSPP), a digital cross-connect (DCS), an optical cross-connect, an optical switch, a router, a switch, a WDM terminal, an access/aggregation device, etc. That is, the node 200 can be any system with ingress and egress signals and switching of channels, timeslots, tributary units, wavelengths, etc. While the node 200 is generally shown as an optical network element, the load balancing systems and methods are contemplated for use with any switching fabric, network element, or network based thereon.

In an exemplary embodiment, the node 200 includes common equipment 210, one or more line modules 220, and one or more switch modules 230. The common equipment 210 can include power; a control module; operations, administration, maintenance, and provisioning (OAM&P) access; and the like. The common equipment 210 can connect to a management system such as a network management system (NMS), element management system (EMS), or the like. The node 200 can include an interface 270 for communicatively coupling the common equipment 210, the line modules 220, and the switch modules 230 to one another. For example, the interface 270 can be a backplane, midplane, a bus, optical or electrical connectors, or the like. The line modules 220 are configured to provide ingress and egress to the switch modules 230 and external to the node 200. In an exemplary embodiment, the line modules 220 can form ingress and egress switches with the switch modules 230 as center stage switches for a three-stage switch, e.g., a three stage Clos switch. The line modules 220 can include optical or electrical transceivers, such as, for example, 1 Gb/s (GbE PHY), 2.5 Gb/s (OC-48/STM-1, OTU1, ODU1), 10 Gb/s (OC-192/STM-64, OTU2, ODU2, 10 GbE PHY), 40 Gb/s (OC-768/STM-256, OTU3, ODU3, 40 GbE PHY), 100 Gb/s (OTU4, ODU4, 100 GbE PHY), etc.

Further, the line modules 220 can include a plurality of connections per module and each module may include a flexible rate support for any type of connection, such as, for example, 155 Mb/s, 622 Mb/s, 1 Gb/s, 2.5 Gb/s, 10 Gb/s, 40 Gb/s, and 100 Gb/s. The line modules 220 can include wavelength division multiplexing interfaces, short reach interfaces, and the like, and can connect to other line modules 220 on remote network elements, end clients, edge routers, and the like. From a logical perspective, the line modules 220 provide ingress and egress ports to the node 200, and each line module 220 can include one or more physical ports. The switch modules 230 are configured to switch channels, timeslots, tributary units, wavelengths, etc. between the line modules 220. For example, the switch modules 230 can provide wavelength granularity (Layer 0 switching); OTN granularity such as Optical Channel Data Unit-1 (ODU1), Optical Channel Data Unit-2 (ODU2), Optical Channel Data Unit-3 (ODU3), Optical Channel Data Unit-4 (ODU4), Optical Channel Data Unit-flex (ODUflex), Optical channel Payload Virtual Containers (OPVCs), etc.; Ethernet granularity; Digital Signal n (DSn) granularity such as DS0, DS1, DS3, etc.; and the like. Specifically, the switch modules 230 can include both Time Division Multiplexed (TDM) (i.e., circuit switching) and packet switching engines. The switch modules 230 can include redundancy as well, such as 1:1, 1:N, etc.

In various exemplary embodiments, the line modules 220 and/or the switch modules 230 can include the packet congestion avoidance circuitry 80 and/or be adapted to perform the WRED process 50 and the service priority logic 70. Those of ordinary skill in the art will recognize the nodes 100, 200 can include other components which are omitted for illustration purposes, and that the systems and methods described herein are contemplated for use with a plurality of different nodes with the nodes 100, 200 presented as an exemplary type of node. For example, in another exemplary embodiment, a node may not include the switch modules 230, but rather have the corresponding functionality in the line modules 220 (or some equivalent) in a distributed fashion. For the nodes 100, 200, other architectures providing ingress, egress, and switching are also contemplated for the systems and methods described herein. In general, the systems and methods described herein contemplate use with any node providing packet switching and/or forwarding, etc.

In an exemplary embodiment, the node 100, 200 adapted for per service differentiation for congestion avoidance through dropping packets based on service priority includes one or more line ports including circuitry adapted to receive an ingress packet; and congestion avoidance circuitry adapted to responsive to no congestion, provide the ingress packet to a queue of one or more queues, and, responsive to congestion, during a congestion window, one of provide the ingress packet to the queue and drop the packet based on a packet dropping capability and service priority of a service associated with the packet.

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the WRED processes 10, 50 and the service priority logic 70 described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, the software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A method for per service differentiation for congestion avoidance through dropping packets based on service priority, the method comprising:
receiving an ingress packet;
responsive to no congestion, providing the ingress packet to a queue of one or more queues; and
responsive to congestion, during a congestion window, one of providing the ingress packet to the queue and dropping the packet based on a packet dropping capability and service priority of a service associated with the packet.

2. The method of claim 1, wherein the congestion is determined if the queue is filled greater than a minimum queue threshold, and wherein the congestion window is when the queue is filled greater than the minimum queue length threshold and less than or equal to maximum queue length threshold.

3. The method of claim 1, further comprising:
responsive to the congestion and outside the congestion window, dropping the packet.

4. The method of claim 1, wherein the service priority is implemented in a Weighted Random Early Detection technique.

5. The method of claim 1, wherein the queue supports traffic comprising a plurality of services, and wherein each of the plurality of services has an associated priority used by the service priority to determine whether or not to drop the packet.

6. The method of claim 1, wherein, in the congestion window, the dropping is not random, but based on the service priority, and, responsive to the congestion and outside of the congestion window, the dropping is for all services.

7. The method of claim 1, wherein the queue supports traffic comprising a plurality of services defined through any of Virtual Local Area Network (VLAN) identifiers, service identifiers in IEEE 802.1ah, a Type of Service (ToS) in IP headers, and tunnel identifiers.

8. The method of claim 1, wherein the service priority is one of user-defined, determined from Differentiated Services (Diff-Serv), and based on IEEE 802.1Q priority.

9. The method of claim 1, wherein the service priority is utilized to differentiate data traffic and control traffic on the queue to provide a higher priority for the control traffic.

10. The method of claim 1, wherein the service priority is utilized to differentiate voice traffic and video traffic on the queue to provide a higher priority for the voice traffic.

11. An apparatus adapted for per service differentiation for congestion avoidance through dropping packets based on service priority, the apparatus comprising:
circuitry adapted to receive an ingress packet; and
congestion avoidance circuitry adapted to
responsive to no congestion, provide the ingress packet to a queue of one or more queues, and
responsive to congestion, during a congestion window, one of provide the ingress packet to the queue and drop the packet based on a packet dropping capability and service priority of a service associated with the packet.

12. The apparatus of claim 11, wherein the congestion is determined if the queue is filled greater than a minimum queue threshold, and wherein the congestion window is when the queue is filled greater than the minimum queue length threshold and less than or equal to maximum queue length threshold, and
wherein the congestion avoidance circuitry is further adapted to, responsive to the congestion and outside the congestion window, drop the packet.

13. The apparatus of claim 11, wherein the service priority is implemented in a Weighted Random Early Detection technique.

14. The apparatus of claim 11, wherein the queue supports traffic comprising a plurality of services, and wherein each of the plurality of services has an associated priority used by the service priority to determine whether or not to drop the packet.

15. The apparatus of claim 11, wherein, in the congestion window, the packet is not dropped randomly, but based on the service priority, and, responsive to the congestion and outside of the congestion window, the packet is always dropped, regardless of the service priority.

16. The apparatus of claim 11, wherein the queue supports traffic comprising a plurality of services defined through any of Virtual Local Area Network (VLAN) identifiers, service identifiers in IEEE 802.1ah, a Type of Service (ToS) in IP headers, and tunnel identifiers.

17. The apparatus of claim 11, wherein the service priority is one of user-defined, determined from Differentiated Services (Diff-Serv), and based on IEEE 802.1Q priority.

18. The apparatus of claim 11, wherein the service priority is utilized to differentiate data traffic and control traffic on the queue to provide a higher priority for the control traffic.

19. The apparatus of claim 11, wherein the service priority is utilized to differentiate voice traffic and video traffic on the queue to provide a higher priority for the voice traffic.

20. A node adapted for per service differentiation for congestion avoidance through dropping packets based on service priority, the node comprising:
one or more line ports comprising circuitry adapted to receive an ingress packet; and
congestion avoidance circuitry adapted to
responsive to no congestion, provide the ingress packet to a queue of one or more queues, and
responsive to congestion, during a congestion window, one of provide the ingress packet to the queue and drop the packet based on a packet dropping capability and service priority of a service associated with the packet.
